(19) United States
(12) Patent Application Publication
(10) Pub. No.: US 2024/0427956 A1
(43) Pub. Date: Dec. 26, 2024

(54) VAPING ARTICLE DESIGN SYSTEM AND METHOD

(71) Applicant: British American Tobacco (Investments) Limited, London (GB)

(72) Inventors: Marcelo Caetano Alexandre MARCELO, London (GB); Erick REIS, London (GB); Samuel KAISER, London (GB); Priscila BRASIL DE SOUZA CRUZ, London (GB)

(21) Appl. No.: 18/262,786

(22) PCT Filed: Jan. 27, 2022
(86) PCT No.: PCT/GB2022/050214

§ 371 Date: Jul. 25, 2023

(30) Foreign Application Priority Data
Jan. 27, 2021 (GB) 2101104.4

(51) Int. Cl. G06F 30/20; A24F 40/70; G06F 111/06; G06F 111/08; G06F 119/18

(52) U.S. Cl. CPC G06F 30/20; A24F 40/70; G06F 2111/06; G06F 2111/08; G06F 2119/18

(57) ABSTRACT

A method of designing a target vaping article includes receiving respective values for a plurality of input parameters, calculating respective values for a plurality of design parameters for the liquid formulation for the vaping article based on the received values for the plurality of input parameters, the plurality of design parameters including at least two parameters selected from: a proportion of a component of a liquid formulation for the vaping article; nicotine and/or other active substance deliveries; a sensory attribute; a number of puffs associated with the vaping article; a heating profile; a flavor composition; physical properties of the vaping article; composition of the vaping article and providing the calculated values as an output.

### PRIORITY CLAIM

The present application is a National Phase entry of PCT Application No. PCT/GB2022/050214, filed Jan. 27, 2022, which claims priority from GB Application No. 2101104.4, filed Jan. 27, 2021, each of which is hereby fully incorporated herein by reference.

### TECHNICAL FIELD

The present disclosure relates to vaping articles, and in particular to systems and methods for designing and simulating vaping articles.

### BACKGROUND

Designing a vaping article involves the selection of various properties of the vaping article. For example, designing a vaping article may include selecting a flavor composition, and an amount of aerosolizable material. The selection of these properties may affect the sensory attributes and nicotine and/or other active substance deliveries of the vaping article.

### SUMMARY

In accordance with a first aspect, this specification describes a method of designing a target vaping article. The method includes receiving respective values for a plurality of input parameters; calculating respective values for a plurality of design parameters for the vaping article based on the received values for the plurality of input parameters; and providing the calculated values as an output. The plurality of design parameters includes at least two parameters selected from a proportion of a component of a liquid formulation for the vaping article; nicotine and/or other active substance deliveries; a sensory attribute; a number of puffs associated with the vaping article; a heating profile; a flavor composition; physical properties of the vaping article; and a composition of the vaping article.

In accordance with a second aspect, the specification describes a non-combustible active substance delivery system, comprising the target vaping article of the first aspect above.

In accordance with a third aspect, the specification describes a computer program including instructions which, when the program is executed by a computer, cause the computer to carry out the method in accordance with the first aspect above.

In accordance with a fourth aspect, the specification describes a computer-readable storage medium comprising instructions which, when executed by a computer, cause the computer to carry out the method in accordance with the first aspect above.

In accordance with a fifth aspect, the specification describes a data processing apparatus comprising a processor and a computer-readable storage medium in accordance with the fourth aspect.

In accordance with a sixth aspect, the specification describes a system including a data processing apparatus in accordance with the fifth aspect and a vaping article manufacturing apparatus. The system is configured to carry out the method in accordance with the first aspect above.

In accordance with a seventh aspect, the specification described a system comprising a vaping article manufactured according to the calculated values for the design parameters output by the method of the first aspect above.

### BRIEF DESCRIPTION OF THE DRAWINGS

Embodiments of the disclosure will now be described, by way of example only, with reference to the accompanying drawings, in which:

FIG. 1 is a schematic block diagram illustrating a system for designing a vaping article.

FIG. 2 is a schematic block diagram illustrating a system component for calculating design parameters for a vaping article.

FIG. 3 is a flow diagram of a method for designing a vaping article.

FIG. 4 is a flow diagram of a method for performing an optimization procedure directed to deriving a descriptor for a target vaping article.

FIG. 5 illustrates performing an example crossover operation to derive a new vaping article descriptor based on existing vaping article descriptors.

FIG. 6 is a schematic illustration of a vaping device comprising a vaping article.

FIG. 7 illustrates comparisons of estimates of aerosol sensory attributes of a vaping article derived according to example embodiments with sensory attribute values obtained using other methods.

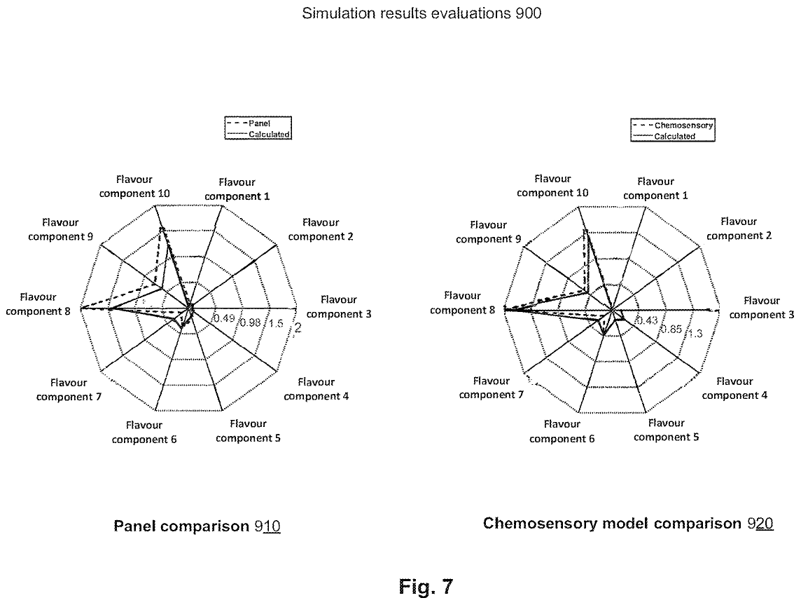

### DETAILED DESCRIPTION

Example implementations provide system(s) and method(s) for designing and simulating vaping articles. The described systems and methods may facilitate designing and prototyping vaping articles in silico reducing the time and cost of developing new vaping articles. Implementations may also facilitate the design of vaping articles having similar sensory attributes to an existing vaping article while using a different composition; having different nicotine and/or other active substance deliveries; being subject to a different heating profile, and/or having different physical properties, e.g. a different quantity of aerosolizable material provided.

As used herein, the term ‘non-combustible active substance delivery system’ is intended to encompass systems that deliver at least one substance to a user, and includes non-combustible aerosol provision systems that release compounds from an aerosol-generating material without combusting the aerosol-generating material, such as electronic cigarettes, and hybrid systems to generate aerosol using a combination of aerosol-generating materials.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement. Where the non-combustible aerosol provision system is a vaping device, the aerosol-generating material may be provided in a component of a device, referred to as a vaping article. In other embodiments, the vaping device may itself be a vaping article.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source.

In some embodiments, the substance to be delivered may be an aerosol-generating material. As appropriate, either material may comprise one or more active constituents, one or more flavors, one or more aerosol-former materials, and/or one or more other functional materials.

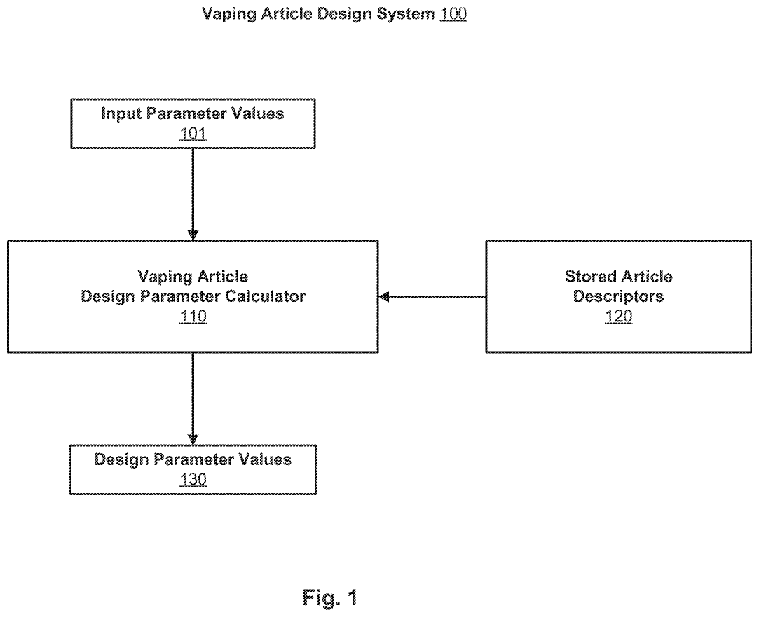

FIG. 1 is a schematic block diagram illustrating a system 100 for designing a vaping article.

The vaping article design system 100 is implemented using one or more suitable computing devices. For example, the one or more computing devices may be any of or any combination of one or more desktop computers, one or more notebook computers, one or more tablet computers, one or more workstation computers, one or more mainframe computers, and one or more blade server computers. In embodiments where the vaping article design system 100 is implemented using a plurality of computing devices, the computing devices may be configured to communicate with each other. The communication may be via one or more peripheral interfaces and/or over one or more networks. The one or more networks may be any of or any combination of the internet, local area networks, cellular networks and wireless networks. The vaping article design system may be implemented using a numerical computing environment and/or framework, e.g. MATLAB, Mathematica, NumPy and/or R. The vaping article design system may also be implemented using one or more suitable programming languages. Examples of suitable programming languages are Python, C, C++, C # and Java.

The vaping article design system 100 includes input parameter values 101, a vaping article design parameter calculator 110, stored vaping article descriptors 120 and design parameter values 130.

The input parameter values 101 are desired and/or set values for parameters of a target vaping article. The parameters may include, but are not limited to, a proportion of a component of a liquid formulation for the vaping article; aerosol sensory attributes; nicotine and/or other active substance deliveries; a heating profile; a flavor composition for the vaping article; a number of puffs associated with the vaping article, and parameters describing the physical properties and/or composition of a vaping article.

Examples of aerosol sensory attributes include taste intensity, mouthful, impact (throat hit), irritation, cooling effect, vapor thickness, bright tobacco taste, dark tobacco taste, bitter, sweet, sour, overall flavor intensity, draw resistance, sweetness on lips, mouth drying, oily mouthcoating, aftertaste intensity, visible aerosol, and other flavor components. The aerosol sensory attributes may be represented using numerical values which are indicative of the sensory impression of a vaping article on consumers according to data and/or models derived using consumer surveys and/or focus groups.

Examples of parameters describing the physical properties and/or composition of the vaping article include a number of puffs associated with the vaping article, for instance the maximum number of puffs achievable from the product under a standard heating regime, the form of the aerosol-generating material (e.g. solid, liquid or gel), the length, circumference, or volume of the article, the mass of aerosol-generating material, and the formulation of the aerosol-generating material, for instance a proportion of water, propylene glycol, glycerol or other components in a liquid formulation. A flavor composition may comprise a proportion of a flavorant in an aerosol-generating material in a solid, liquid, or gel form. A heating profile may define a given heating gradient or pattern to be applied to the vaping article.

The design parameter values 130 are calculated values for a number of design parameters of the target vaping article. The design parameters may be any number of the parameters described above in relation to the input parameters 101. The design parameters may include one or more parameters of the vaping article which were not input parameters.

The design parameters may be understood as parameters for which values are to be chosen such that the target vaping article has the provided values for the input parameters, or as close as is achievable. For example, the input parameter values may indicate that the target vaping article is desired to have certain sensory attribute values and include an aerosol-generating material in liquid form consisting of given constituents; and the values for the design parameters may describe the physical properties and/or composition of the target vaping article such that the target vaping article has properties matching, or at least resembling, the received values for the input parameters.

The vaping article design parameter calculator 110 receives the input parameter values 101, and calculates the design parameter values 130 for a vaping article based on the received input parameter values 101.

In calculating the design parameter values 130, the vaping article design parameter calculator 110 may derive a target vaping article descriptor. Vaping article descriptors may include values for the design parameters and values for the input parameters. The values of a given vaping article descriptor for the design parameters and input parameters may be unscaled values for the parameters, i.e. each of the values may be of the same scale as the corresponding input parameter or design parameter value. Alternatively, the values of a given vaping article descriptor for the design parameters and input parameters may have undergone feature scaling, e.g. each the values for the parameter may have been rescaled using an appropriate method such as min-max normalization, mean normalization or standardization. Different rescaling methods may be appropriate for different parameters and, as such, the values of a given vaping article descriptor for different parameters may be rescaled according to different methods. In some instances, the values of a given vaping article descriptor for some of the parameters may have undergone feature scaling while others may have not. Where the values of the target vaping article descriptor have undergone feature scaling, the vaping article design parameter calculator 110 may transform at least the values of the target vaping article descriptor into an appropriate scale for the design parameter values, e.g. design parameter values understandable by a design system user and/or usable for manufacturing the target vaping article.

Vaping article descriptors may be implemented using any suitable data structure. Suitable data structures include, but are not limited to, arrays, vectors, matrices, rows and/or columns of matrices, in-memory objects, markup language files, serialized binary data, database entries and text data.

The target vaping article design parameter calculator 110 may derive the target vaping article descriptor by performing an optimization procedure, which may be a stochastic optimization procedure. For example, the optimization procedure may be any of particle swarm optimization, ant colony optimization, simulated annealing, a Monte Carlo algorithm, Runge-Kutte methods, a genetic algorithm, or any combination thereof. Where a genetic algorithm is used, it may be a real coded genetic algorithm. The optimization procedure may be directed towards deriving a target vaping article having a maximal fitness. The fitness of a given vaping article descriptor may be based on differences between the input parameter values 101, or a feature scaling thereof, and the corresponding values of the target vaping article descriptor.

The fitness of a given vaping article descriptor may be measured using a fitness function or loss function. Where a fitness function is used, a greater value of the fitness function for the given vaping article descriptor indicates a greater fitness. Where a loss function is used, a lesser value of the loss function for the vaping article descriptor indicates a greater fitness. For example, the fitness of a vaping article descriptor may be inversely related to the root mean square deviation, also referred to as the root mean square error, between the input parameter values 101, or a feature scaling thereof, and the corresponding values of the target vaping article descriptor, and, this root mean square deviation used as a loss function. This root mean square deviation may be denoted as:

$$\frac{1}{N} \sqrt{{\sum }_{i = 1}^{N} {( {p}_{i} - {c}_{i} )}^{2}} ,$$

where N is the number of input parameters, pᵢ is the ith input parameter value, or a feature scaling thereof, and cᵢ is the value of a given vaping article descriptor for the ith input parameter.

The stored vaping article descriptors 120 may be used by the vaping article design parameter calculator 110 in the derivation of the design parameter values 130. For example, the stored vaping article descriptors may be used to derive the target vaping article descriptor. The stored vaping article descriptors 120 may be implemented using any suitable data structure for vaping article descriptors, including those previously referred to. The stored vaping article descriptors 120 may be stored using any suitable data storage mechanism, e.g. file system storage, database storage or an in-memory cache. The stored vaping article descriptors 120 may have been derived using measurements of physical qualities and properties; chemometric analysis; and/or results of consumer focus groups and/or panels. Some of the stored vaping article descriptors 120 may have been derived using a chemosensory model such as that described in WO2018007789A1, the contents of which are incorporated herein by reference.

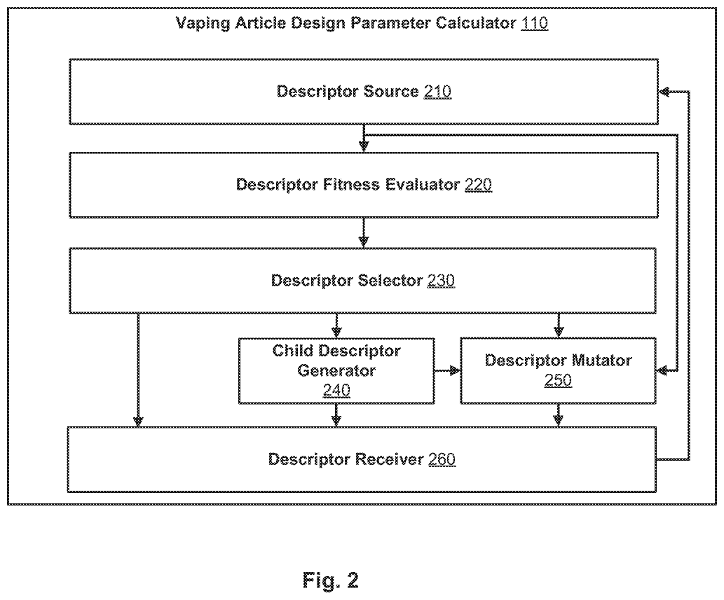

The target vaping article descriptor may be derived by using a plurality of the stored vaping article descriptors, or a feature scaling thereof, as initial vaping article descriptors. The vaping article design calculator 110 may evaluate the fitness of the initial vaping article descriptors and derive new vaping article descriptors based on a selected subset of them, e.g. the fittest j initial vaping article descriptors may be used to derive the new vaping article descriptors. The fitness of these new vaping article descriptors may then be evaluated and a selected subset of the new vaping article descriptors used to generate a further generation of vaping article descriptors. Subsequent generations may then be generated, each of the subsequent generations derived from a selected subset of the vaping article descriptors of the preceding generation. The target vaping article descriptor may be the fittest vaping article descriptor of the last generation. A related example embodiment of the vaping article design parameter calculator 110 is described in relation to FIG. 2.

The vaping article design system 100 may also include a vaping article manufacturing apparatus (not shown). The design parameter values may be provided to the vaping article manufacturing apparatus and used to manufacture the target vaping article.

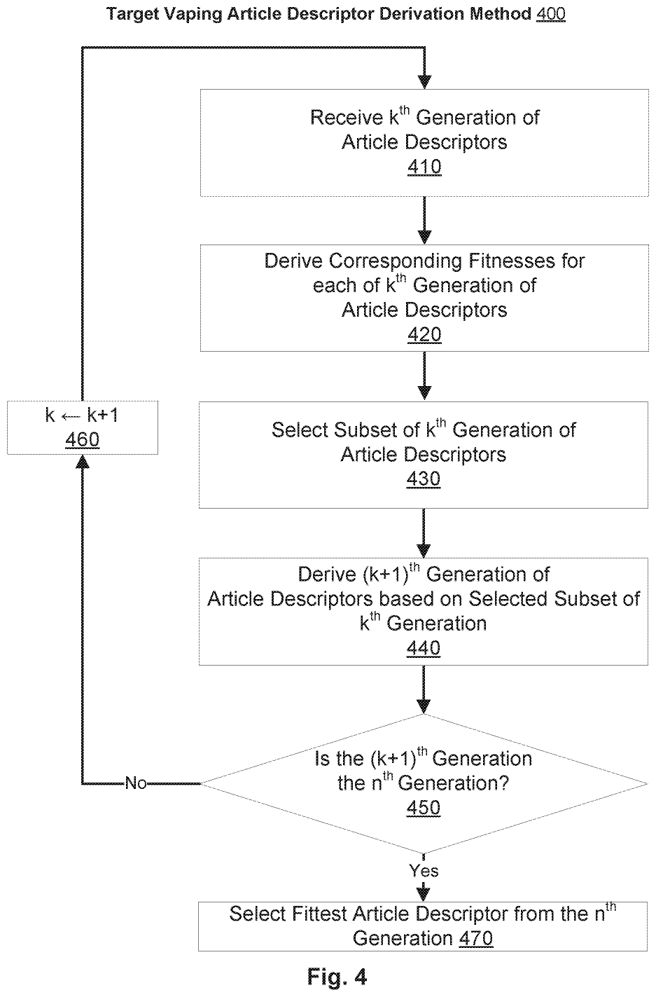

FIG. 2 is a schematic block diagram illustrating an example embodiment of the component 110 of the vaping article design system 100 for calculating design parameters for a vaping article. The illustrated example embodiment may perform the vaping article optimization method 400 described in relation to FIG. 4.

The illustrated embodiment of the vaping article design parameter calculator 110 includes a descriptor source 210, a descriptor fitness evaluator 220, a descriptor selector 230, a child descriptor generator 240, a descriptor mutator 250 and a descriptor receiver 260. The illustrated vaping article design parameter calculator uses these included components to perform one or more processing iterations in which vaping article descriptors are generated.

The descriptor source 210 is a source of vaping article descriptors. The descriptor source may be a source of stored vaping article descriptors 120. These stored vaping article descriptors 120 may be retrieved by the descriptor source 210 from a suitable data storage system, such as a database or file storage system, or from an in-memory cache. Where vaping article descriptors have already been generated, e.g. in a preceding iteration, the descriptor source may also be a source of these generated vaping article descriptors. These generated vaping article descriptors may have been retrieved or received from the descriptor receiver 260.

The descriptor fitness evaluator 220 receives vaping article descriptors from the descriptor source 210. The received vaping article descriptors may be a set of stored vaping article descriptors in the first iteration and, in subsequent iterations, may be the vaping article descriptors derived and/or otherwise received by the descriptor receiver 260 during the preceding iteration. The descriptor fitness evaluator evaluates the fitness of each of the received vaping article descriptors using a fitness function or loss function based on the input parameter values, as previously described.

The descriptor selector 230 receives the vaping article descriptors and associated fitness values from the descriptor fitness evaluator.

If the descriptor selector 230 determines that the final iteration has been reached then the descriptor selector may select the fittest vaping article descriptor of the received vaping article descriptors based on the associated fitness values and provide it to the descriptor receiver 260 with an indication that the final iteration has been reached. The descriptor selector 230 may determine that the final iteration has been reached if an iteration limit has been reached, e.g. the current iteration is the 100^{th} iteration and only a maximum of 100 iterations are to be performed. Alternatively, the descriptor selector 230 may determine that the final iteration has been reached if the fittest vaping article descriptor has a fitness greater than a threshold fitness, e.g. if the loss function is below a given value.

If the descriptor selector 230 does not determine that the final iteration has been reached, the descriptor selector may proceed with one or more of the following operations.

The descriptor selector 230 may select one or more elite descriptors and provide them to the descriptor receiver 260. The one or more elite descriptors may be the K vaping article descriptors of the received vaping article descriptors having the greatest fitnesses.

The descriptor selector may also select a plurality of parent vaping article descriptors and provide them to the child descriptor generator 240. The plurality of parent descriptors may be the N vaping article descriptors of the received vaping article descriptors having the greatest fitnesses, where N may be greater than K. Alternatively, a probabilistic procedure may be used, such as fitness proportionate selection, where the parent descriptors are selected by selecting descriptors from the received vaping article descriptors with a probability based on their fitness, i.e. vaping article descriptors with a greater fitness are more likely to be selected.

The descriptor selector 230 may also select one or more vaping article descriptors for mutation and provide them to the descriptor mutator 250. The one or more descriptors for mutation may be selected at random from the received vaping article descriptors or from a subset of the received vaping article descriptors, e.g. the fittest M of the received vaping article descriptors, or the parent tobacco product descriptors. The one or more descriptors for mutation may also be selected by selecting descriptors from the received vaping article descriptors with a probability based on their fitness.

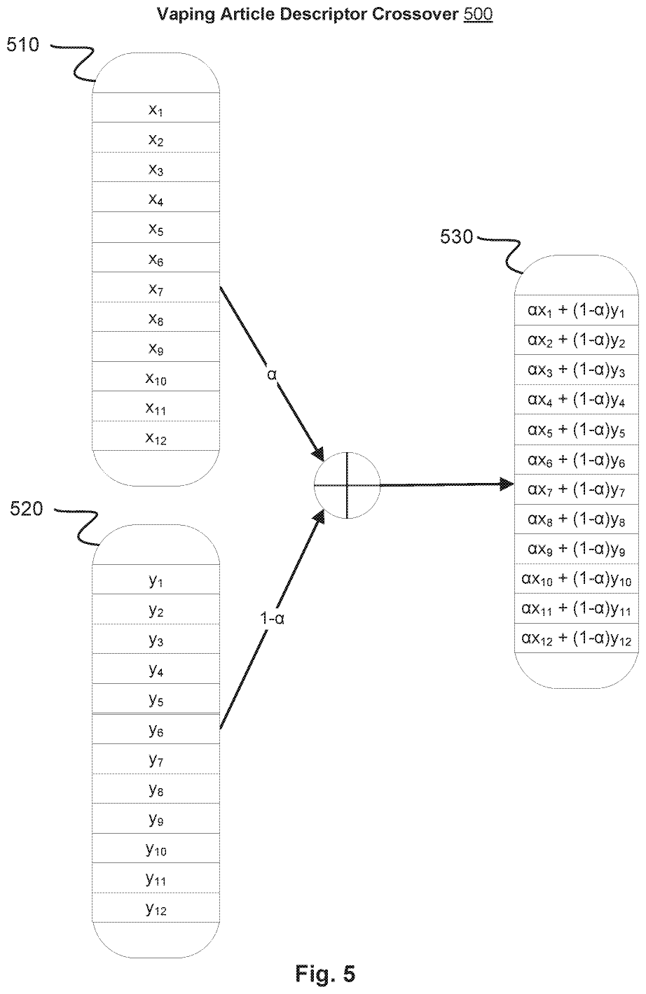

The child descriptor generator 240 receives the plurality of parent vaping article descriptors from the descriptor selector and uses them to generate child vaping article descriptors. Each child vaping article descriptor may be generated by performing a crossover operation of two or more of the parents. The parents to be crossed over to generate each child may be chosen (pseudo)randomly or according to fixed combinations, e.g. the first parent with the second parent, the third parent with the fourth parent etc. The crossover operation may linearly combine two or more parent descriptors, with each of the parents weighted in the combination using a (pseudo)random variable. For example, where two parent descriptors, x and y, are used to generate a child descriptor, c, the child descriptor may be:

$$c = α x + ( 1 - α ) y ,$$

where α is a (pseudo)random variable between 0 and 1, as illustrated in FIG. 5.

The descriptor mutator 250 may receive the one or more vaping article descriptors for mutation from the descriptor selector and uses them to generate mutated vaping article descriptors. Alternatively or additionally, the descriptor mutator may receive one or more child vaping article descriptors for mutation from the child descriptor generator. Each mutated vaping article descriptor may be generated by performing a crossover operation of a descriptor for mutation with a stored vaping article descriptor received via the descriptor source 210. The crossover operation may linearly combine a descriptor for mutation with a stored vaping article descriptor, with each weighted in the combination using a (pseudo)random variable. For example, where a descriptor for mutation, d, and a stored descriptor, s, are used to generate a mutated descriptor, m, the mutated descriptor may be:

$$m = ( 1 - β ) d + β s ,$$

where β is a pseudo(random) variable between 0 and 1. β may be constrained to be or be more likely to be towards the lower end of this stated range, e.g. between 0 and 0.1.

If the descriptor receiver 260 receives an indication that the final iteration has been reached, the descriptor receiver 260 also receives the fittest vaping article descriptor of the final iteration, which is the target vaping article descriptor. The descriptor receiver 260 uses the target vaping article descriptor to obtain the design parameter values, as previously described, and provides them as an output.

Otherwise, the descriptor receiver 260 receives the one or more elite vaping article descriptors; the child vaping article descriptors; and the one or more mutated vaping article descriptors. The descriptor receiver may provide the vaping article descriptors which it has received to the descriptor source 210.

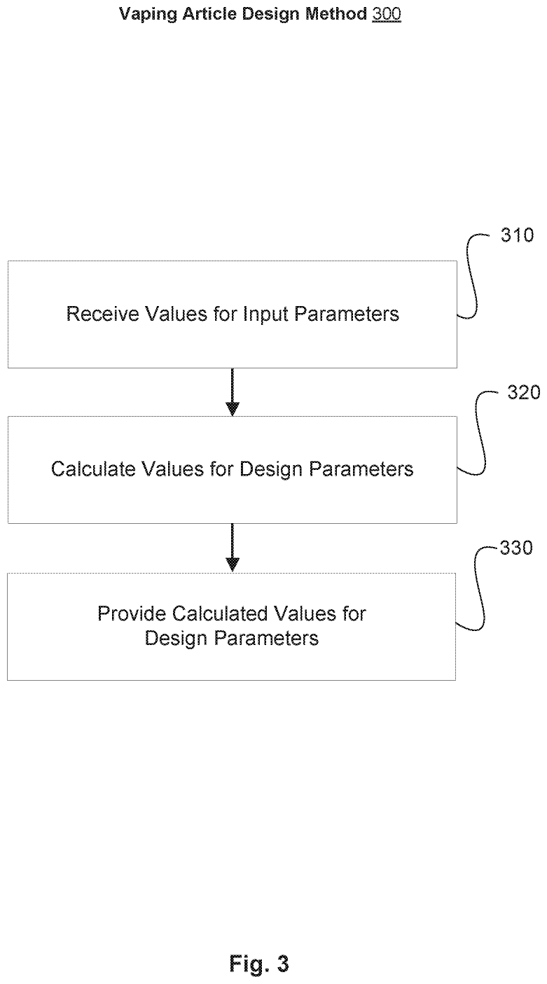

FIG. 3 is a flow diagram illustrating an example method for designing a target vaping article. The method may be performed by executing computer-readable instructions using one or more processors of one or more computing devices, e.g. the one or more computing devices implementing the vaping article design system 100.

At 310, values for a plurality of input parameters are received. The values for the plurality of input parameters are desired and/or set values for parameters of the target vaping article. The parameters may include, but are not limited to, one or more of a proportion of a component of a liquid formulation for the vaping article; aerosol sensory attributes; nicotine and/or other active substance deliveries; a heating profile; a flavor composition for the vaping article; a number of puffs associated with the vaping article, and parameters describing the physical properties and/or composition of a vaping article; and parameters describing the physical properties and/or composition of a vaping article. Examples of such parameters are described in detail in relation to the input parameter values 101 of vaping article design system 100.

At 320, values for a plurality of design parameters for the target vaping article are calculated based on the received values for the plurality of input parameters. The design parameters may be any number of the parameters described above as being usable as input parameters. The design parameters may include one or more parameters of the vaping article which were not input parameters.

The plurality of values for the design parameters may be calculated such that the target vaping article has the received values for the plurality of input parameters, or as close as is achievable. For example, the values for the plurality of input parameters may indicate that the target vaping article is desired to have certain sensory attribute values and have an e-liquid formulation comprising given flavor descriptors, such as menthol; and the values for the design parameters may describe the physical properties and/or composition of the target vaping article and the proportions of the base constituents and flavor compounds forming the e-liquid such that the target vaping article has properties matching, or at least resembling, the received values for the input parameters.

The calculation of the values for the plurality of design parameters may include deriving a target vaping article descriptor. Vaping article descriptors may include values for the plurality of design parameters and values for the plurality of input parameters. These value of a given vaping article descriptor may be unscaled or may have undergone feature scaling, as described in relation to the deriving of vaping article descriptors in the example vaping article design system 100. Where the values of the target vaping article descriptor have undergone feature scaling, the calculation of the values for the plurality of design parameters may include transforming at least the values of the target vaping article descriptor for the plurality of design parameters into a scale appropriate for being provided as an output. For example, the values may be transformed into a scale understandable by a designer of vaping articles and/or usable for manufacturing the target vaping article.

Vaping article descriptors may be implemented using any suitable data structure. Suitable data structures include, but are not limited to, arrays, vectors, matrices, rows and/or columns of matrices, in-memory objects, markup language files, serialized binary data, database entries and text data.

The target vaping article descriptor may be derived by performing an optimization procedure, which may be a stochastic optimization procedure. For example, the optimization procedure may be any of particle swarm optimization, ant colony optimization, simulated annealing, a Monte Carlo algorithm, Runge-Kutte methods, a genetic algorithm, or any combination thereof. Where a genetic algorithm is used, it may be a real coded genetic algorithm. The optimization procedure may be directed towards deriving a target vaping article having a maximal fitness. The fitness of a given vaping article descriptor may be based on differences between the values for the plurality of input parameters, or a feature scaling thereof, and the corresponding values of the target vaping article descriptor.

The fitness of a given vaping article descriptor may be measured using a fitness function or loss function. Where a fitness function is used, a greater value of the fitness function for the given vaping article descriptor indicates a greater fitness. Where a loss function is used, a lesser value of the loss function for the vaping article descriptor indicates a greater fitness. For example, the fitness of a vaping article descriptor may be inversely related to the root mean square deviation, also referred to as the root mean square error, between the values for the plurality of input parameters, or a feature scaling thereof, and the corresponding values of the target vaping article descriptor, and, this root mean square deviation used as a loss function. This root mean square deviation may be denoted as:

$$\frac{1}{N} \sqrt{{\sum }_{i = 1}^{N} {( {p}_{i} - {c}_{i} )}^{2}} ,$$

where N is the number of input parameters, pᵢ is the value for the ith of the plurality of input parameters, or a feature scaling thereof, and cᵢ is the value of a given vaping article descriptor for the ith of the plurality of input parameters.

The calculation of the values for the plurality of design parameters may be based on a plurality of stored vaping article descriptors. For example, the target vaping article descriptor may be derived using the plurality of stored vaping article descriptors. The stored vaping article descriptors may be implemented using any suitable data structure for vaping article descriptors, include those previously referred to. The plurality of stored vaping article descriptors may be retrieved from any suitable data storage mechanism storing the plurality, or a greater plurality, of vaping article descriptors, e.g. the stored vaping article descriptors may be retrieved from file system storage, database storage or an in-memory cache.

The target vaping article descriptor may be derived by using a plurality of the stored vaping article descriptors, or a feature scaling thereof, as initial vaping article descriptors. The fitness of the initial vaping article descriptors may be evaluated and new vaping article descriptors may be derived based on a selected subset of them, e.g. the fittest J initial vaping article descriptors may be used to derive the new vaping article descriptors. The fitness of these new vaping article descriptors may then be evaluated and a selected subset of the new vaping article descriptors used to generate a further generation of vaping article descriptors. Subsequent generations may then be generated, each of the subsequent generations derived from a selected subset of the vaping article descriptors of the preceding generation. The target vaping article descriptor may be the fittest vaping article descriptor of the last generation. A related example method for deriving the target vaping article descriptor is described in relation to FIG. 4.

In operation 330, the values for the design parameters are provided as an output. The values for the design parameters may be displayed to a vaping article designer using a suitable graphical interface and/or may be used by a vaping article manufacturing apparatus to manufacture the target vaping article.

FIG. 4 is a flow diagram illustrating an example method 400 for deriving a target vaping article descriptor. The method may be performed by executing computer-readable instructions using one or more processors of one or more computing devices, e.g. the one or more computing devices implementing the vaping article design system 100.

The described operations are repeated for a number of iterations. A total of (n−1) iterations are performed to derive an nth generation of vaping article descriptors. The number n is an integer greater than or equal to two. The number n may be a fixed number or may denote the generation in which an end criterion is met. For example, n may denote the generation in which the fittest vaping article descriptor has a fitness greater than a threshold fitness, e.g. the loss function value for that descriptor is below a given value.

In operation 410, the kth generation of vaping article descriptors is received. If the kth generation is the first generation of vaping article descriptors, the received vaping article descriptors may be received from a suitable data storage system, such as a database or file storage system, or from an in-memory cache. Otherwise, the received vaping article descriptors may be those derived in the preceding generation.

In operation 420, corresponding fitnesses for each of the kth generation of vaping article descriptors are derived. The fitness of each of the kth generation of vaping article descriptors may be derived using a fitness function or loss function based on the values of the respective vaping article descriptor for the input parameters, as previously described.

In operation 430, one or more subsets of the kth generation of vaping article descriptors are selected.

An elite subset of vaping article descriptors may be selected. The elite subset of vaping article descriptors may be the M vaping article descriptors of the kth generation of vaping article descriptors having the greatest fitnesses.

A parent subset of vaping article descriptors may be selected. The parent subset may be the M vaping article descriptors of the vaping article descriptors kth generation of vaping article descriptors having the greatest fitnesses, where M may be greater than K. Alternatively, a probabilistic procedure may be used to select the parent subset, such as fitness proportionate selection, where the parent descriptors are selected by selecting descriptors from the kth generation of vaping article descriptors with a probability based on their fitness, i.e. vaping article descriptors with a greater fitness are more likely to be selected.

A mutatee subset of vaping article descriptors may be selected. The mutatee subset may be selected at random from the kth generation of vaping article descriptors or from a subset of the kth generation of vaping article descriptors, e.g. the fittest M of the kth generation of vaping article descriptors, or the parent subset of kth generation of vaping article descriptors. The mutatee subset may also be selected by selecting descriptors from kth generation of vaping article descriptors with a probability based on their fitness.

In operation 440, a (k+1)th generation of vaping article descriptors is derived based on the one or more selected subsets of the kth generation of vaping article descriptors.

The (k+1)th generation of vaping article descriptors may include the elite subset of the kth generation of vaping article descriptors.

The (k+1)th generation of vaping article descriptors may include child descriptors derived based on the parent subset of the kth generation of vaping article descriptors. Each child vaping article descriptor may be generated by performing a crossover operation of two or more of the parent subset. The parents to be crossed over to generate each child may be chosen (pseudo)randomly or according to fixed combinations, e.g. the first parent with the second parent, the third parent with the fourth parent etc. The crossover operation may linearly combine two or more of the descriptors in the parent subset, with each of the parents weighted in the combination using a (pseudo)random variable. For example, where two parent descriptors, x and y, are used to generate a child descriptor, c, the child descriptor may be:

$$c = α x + ( 1 - α ) y ,$$

where α is a (pseudo)random variable between 0 and 1, as illustrated in FIG. 5.

The (k+1)th generation of vaping article descriptors may include mutated vaping article descriptors derived based on the mutatee subset of the kth generation of vaping article descriptors. The (k+1)th generation of vaping article descriptors may also include mutated vaping article descriptors derived based on a mutatee subset of the child vaping article descriptors. Each mutated vaping article descriptor may be generated by performing a crossover operation of a descriptor from a mutatee subset with a stored vaping article descriptor. The crossover operation may linearly combine a vaping article descriptor from a mutatee subset with a stored vaping article descriptor, with each weighted in the combination using a (pseudo)random variable. For example, where a mutatee descriptor, d, and a stored descriptor, s, are used to generate a mutated descriptor, m, the mutated descriptor may be:

$$m = ( 1 - β ) d + β s ,$$

where β is a pseudo(random) variable between 0 and 1. β may be constrained to be or be more likely to be towards the lower end of this stated range, e.g. between 0 and 0.1.

In operation 450, it is determined whether the (k+1)th generation of descriptors is the nth generation of descriptors. Where a fixed number of iterations are performed, the determination may comprise determining whether (k+1) is equal to n. In embodiments where n denotes that an end criterion is met, determining whether the (k+1)th generation is the nth generation includes the determining whether the (k+1)th generation of descriptors satisfies the end criterion. For example, it may be determined whether the fittest vaping article descriptor of the (k+1)th generation has a fitness greater than a threshold fitness, e.g. the loss function value for that descriptor is below a given value. In response to it being determined that the (k+1)th generation of descriptors is the nth generation of descriptors, the method continues to operation 470. Otherwise, the method continues to operation 460.

Operation 460 indicates that the operations described above are to be repeated for the next generation. The value k may be understood to have been incremented to (k+1). In some embodiments, a variable storing the value of or a value relating to k may be increment, e.g. embodiments using a for loop and a fixed number of iterations. However, in other embodiments, no such variable may be used or maintained and instead the illustrated incrementing of k merely denotes that execution continues for the next generation.

In operation 470, the vaping article descriptor of the nth generation of vaping article descriptors having the greatest fitness is selected as the target vaping article descriptor. As described at 320 of method 300, the target vaping article descriptor is usable to derive values for the plurality of design parameters.

FIG. 5 illustrates performing an example crossover operation 500 to derive a new vaping article descriptor based on existing vaping article descriptors. The described crossover operation may be performed by the child descriptor generator 240 and/or the descriptor mutator of the vaping article design parameter calculator 110 described in relation to FIG. 2. The described crossover operation may also be performed in child generation and/or mutation operations performed in the descriptor generation derivation operation 440 of the target vaping article descriptor derivation method 400.

The illustration 500 includes a first vaping article descriptor 510, a second vaping article descriptor 520 and a derived vaping article descriptor 530.

The first vaping article descriptor 510 is a vaping article descriptor implemented as described above in relation to the system 100 and/or the method 300. The first vaping article descriptor 510 may be a stored vaping article descriptor; a vaping article descriptor derived in a preceding iteration of vaping article descriptor derivations; or a vaping article descriptor derived during the present iteration, e.g. a child vaping article descriptor which is to undergo mutation. The first vaping article descriptor 510 may be represented as a vector, x, having elements xᵢ. Each of the elements may be a value for a respective input or design parameter. In the illustrated example, the first vaping article descriptor 510 has 12 elements, x₁-x₁₂.

The second vaping article descriptor 520 is also a vaping article descriptor implemented as described above in relation to the system 100 and/or the method 300. The second vaping article descriptor 520 may be a stored vaping article descriptor; a vaping article descriptor derived in a preceding iteration of vaping article descriptor derivations; or a vaping article descriptor derived during the present iteration, e.g. a child vaping article descriptor which is to undergo mutation. The second vaping article descriptor 520 may be represented as a vector, y, having elements yᵢ. Each of the elements may be a value for a respective input or design parameter. Each of the elements, yᵢ, may be a value for the same respective input or design parameter as the corresponding element of the first vaping article descriptor, xᵢ. In the illustrated example, the second vaping article descriptor 520 has 12 elements, y₁-y₁₂, which are values for the same 12 parameters as those in the first vaping article descriptor, x₁-x₁₂,

The derived vaping article descriptor 530 is derived by linearly combining, e.g. calculating a weighted sum of, the first vaping article descriptor 510 and the second vaping article descriptor 520. In the illustrated example, the derived vaping article descriptor 530 is derived using a (pseudo)randomly generated number, a, which is in the range 0 to 1, and the derived vaping article descriptor is the sum of the first vaping article descriptor 510 multiplied by a and the second vaping article descriptor 520 multiplied by (1−α), i.e.:

$$z = α x + ( 1 - α ) y ,$$

where z is a vector representing the derived vaping article descriptor 530. Therefore, as illustrated, the elements, zᵢ, of z are:

$${z}_{i} = α {x}_{i} + ( 1 - α ) {y}_{i}$$

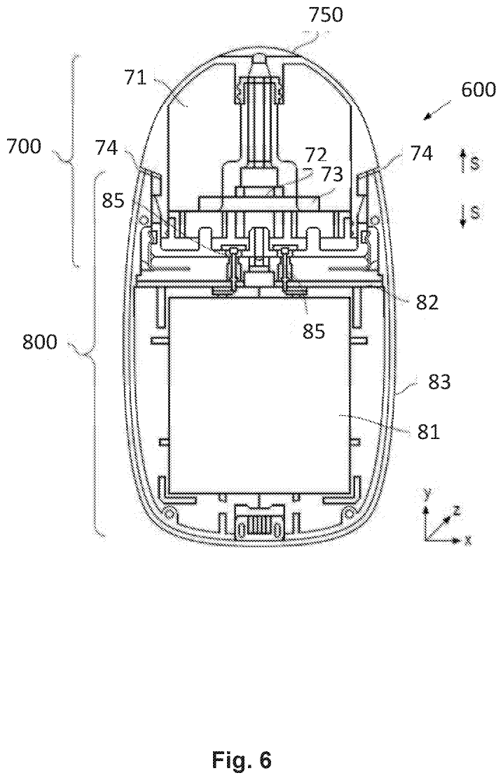

FIG. 6 is a schematic illustration of a vapor provision system, also referred to as a vaping device or e-cigarette. Vapor provision systems can operate by generating vapor from a liquid, including by heating or by vibration. The liquid is stored in a reservoir or tank within the system, and a new supply of liquid is required when the reservoir becomes empty. The vapor provision system may be configured to include a disposable portion, which may comprise the reservoir or tank. Such a disposable portion may be referred to as a vaping article. In alternative embodiments, the vapor provision system itself may be a vaping article according to the present disclosure.

Liquids and gels comprising appropriate compounds can be considered as substrate materials from which an aerosol or vapor can be generated by heating or otherwise. Unless particularly stated, the present disclosure is to be understood as applying equally to both liquids and gels. Generic terms such as “aerosolizable substrate material”, “aerosol-generating material”, “aerosolizable substrate fluid” or “aerosolizable fluid” may be used to encompass both liquids and gels (and any similar materials). The present application uses the term “liquid”, but this is for simplicity only, and “liquid” should be understood to include gels and any other aerosolizable substrate materials unless stated otherwise. The aerosolizable substrate material, as a liquid or a gel, may be held in a reservoir in a “free-flowing” form, in that it is not absorbed into a matrix of absorbent material such as a sponge or wadding placed inside the reservoir.

FIG. 6 is a cross-sectional view through an example e-cigarette 600, comprising a target vaping article in accordance with examples of the present disclosure. The e-cigarette 600 comprises two main components, namely a cartomizer 700 and a control unit or power unit 800. The cartomizer 700 includes a chamber, tank or reservoir 71 containing a supply of liquid, a heater 72 to generate vapor from the liquid, and a mouthpiece 750. The liquid in the reservoir 71 (sometimes referred to as e-liquid or source liquid) may include nicotine in an appropriate solvent, and may include further constituents, for example, to aid aerosol formation, and/or for additional flavoring. Nicotine may be absent from the liquid, in other examples. The cartomizer 700 further includes a wick 73 or similar facility to transport a small amount of liquid from the reservoir 71 to a heating location on or adjacent the heater 72. The combination of a wick and a heater may be referred to as an atomizer or vaporizer. The control unit 800 includes within a housing 83 a re-chargeable cell or battery 81 to provide power to the e-cigarette 600 and a printed circuit board 82 (PCB) for generally controlling the e-cigarette. When the heater 72 receives power from the battery 81, as controlled by the PCB 82, the heater 72 vaporizes the liquid from the wick 73 and this vapor is then inhaled by a user through the mouthpiece 750.

The cartomizer 700 and the control unit 800 are detachable from one another by separation in a direction along a longitudinal axis of the device, indicated in FIG. 6 by the arrows S, but are joined together when the device 600 is in use so as to provide mechanical and electrical connectivity between the cartomizer 700 and the control unit 800. Hence, the cartomizer and the control unit are separably connectable; they can be joined (coupled) together or separated apart according to user need. In this particular example, when the liquid in the reservoir 71 has been depleted, the cartomizer 700 is removed and a new cartomizer is attached to the control unit 800. Accordingly, the cartomizer 700 may sometimes be referred to as a disposable portion of the e-cigarette 600, while the control unit 800 represents a re-usable portion. Alternatively, the cartomizer may be configured so that the reservoir is refillable with liquid, and the cartomizer may or may not require detachment from the control unit for access to a filling port.

When a user inhales through the mouthpiece 750, the device 600 is activated and air flows into the cartomizer 700 through the air inlet hole 714 (via a pathway leading from ventilation slots 74 defined at the juncture between the top edge of the control unit housing 83 and a lip 740 between the lower portion 710 and the upper portion 720 of the cartomizer 700). This incoming air flows past the heater (not visible in FIG. 6), which receives electrical power from the battery in the control unit 800 so as to vaporize liquid supplied from the reservoir 71 by the wick 73. This vaporized liquid is then incorporated or entrained into the airflow 80 through the cartomizer, and hence is drawn out of the cartomizer 700 through the mouthpiece 750 for inhalation by the user. The illustration 900 includes a panel comparison graph 910.

The panel comparison graph 910 compares results for aerosol sensory attributes estimated by an embodiment of the method described herein with the results provided by a panel of consumers evaluating the aerosol sensory attributes. As the graph 910 illustrates, the results estimated by the embodiment are close to those given by the panel of consumers. Therefore, the described systems and methods may reduce the number of consumer evaluations, e.g. using surveys or focus groups, undertaken to evaluate articles during the design process.

The chemosensory model comparison graph 920 compares results for aerosol sensory attributes estimated by an embodiment of the method described herein with the results provided using a chemosensory model. As the graph 920 illustrates, the results estimated by the embodiment are close to those given by the chemosensory model. The chemosensory model uses chemical fingerprints to estimate the smoke sensory attributes. Chemical fingerprints are information dense and require a significant amount of processing. The chemosensory model uses more computational resources than the described systems and methods. Therefore, the described systems and method may reduce the computational resources used, e.g. using surveys or focus groups, to derive accurate estimates for the aerosol sensory attributes of an article.

In order to address various issues and advance the art, the entirety of this disclosure shows by way of illustration various embodiments in which that which is claimed may be practiced and provide for superior design and simulation of vaping articles. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. A method of designing a target vaping article, the method comprising:
receiving respective values for a plurality of input parameters;
calculating respective values for a plurality of design parameters for a liquid formulation for the target vaping article based on the received values for the plurality of input parameters, the plurality of design parameters comprising at least two parameters selected from:
a proportion of a component of the liquid formulation for the target vaping article,
nicotine or another active substance deliveries,
a sensory attribute,
a number of puffs associated with the target vaping article,
a heating profile,
a flavor composition,
physical properties of the target vaping article, and
composition of the target vaping article; and
providing the calculated values of the plurality of design parameters as an output.

2. The method of claim 1, wherein calculating values for the plurality of design parameters comprises deriving a target vaping article descriptor, wherein the target vaping article descriptor comprises values for the plurality of design parameters and values for the plurality of input parameters for the target vaping article.

3. The method of claim 2, wherein deriving the target vaping article descriptor comprises performing an optimization procedure directed to deriving a target vaping article descriptor having a maximal fitness.

4. The method of claim 3, wherein a fitness of a given target vaping article descriptor is based on differences between values of the given target vaping article descriptor for the plurality of input parameters and corresponding values based on the received values for the plurality of input parameters.

5. The method of claim 4, wherein the fitness of the given target vaping article is inversely related to a root mean square deviation between the values of the given target vaping article descriptor for the input parameters and corresponding values based on the received values for the plurality of input parameters.

6. The method of claim 3, wherein performing the optimization procedure comprises, repeating for each k between 1 and (n−1), where n≥2:
receiving a kth generation of target vaping article descriptors;
deriving corresponding fitnesses for each of the kth generation of target vaping article descriptors;
selecting one or more subsets of the kth generation of target vaping article descriptors based on the corresponding fitnesses; and
deriving a (k+1)th generation of target vaping article descriptors based on the one or more subsets of the kth generation of target vaping article descriptors,
wherein the target vaping article descriptor is the vaping article descriptor of the nth generation having a greatest fitness.

7. The method of claim 6, wherein deriving the (k+1)th generation of target vaping article descriptors comprises deriving one or more child vaping article descriptors, wherein each of the one or more child vaping article descriptors is based on a respective two or more of the subset of the kth generation of the target vaping article descriptors.

8. The method of claim 7, wherein each of the one or more child vaping article descriptors is a linear combination of the respective two or more of the subset of the kth generation of target vaping article descriptors.

9. The method of claim 7, wherein deriving the (k+1)th generation of target vaping article descriptors comprises mutating at least one of the one or more child vaping article descriptors.

10. The method of claim 3, wherein the optimization procedure is a stochastic optimization procedure.

11. The method of claim 10, wherein the stochastic optimization procedure is a genetic algorithm.

12. The method of claim 11, wherein the genetic algorithm is a real coded genetic algorithm.

13. The method of claim 10, wherein the optimization procedure comprises at least one selected from particle swarm optimization, ant colony optimization, simulated annealing, a Monte Carlo algorithm, Runge-Kutte methods, a genetic algorithm, or any combination thereof.

14. The method of claim 1, wherein the values for the plurality of design parameters are calculated based on a plurality of stored vaping article descriptors, wherein each of the stored vaping article descriptors comprises values for the plurality of design parameters and values for the plurality of input parameters for a corresponding vaping article.

15. The method of claim 14, further comprising deriving one or more of the plurality of stored vaping article descriptors using chemometric analysis.

16. The method of claim 1, wherein the plurality of input parameters comprise at least two parameters selected from:
a proportion of a component of a liquid formulation;
nicotine or another active substance deliveries;
a sensory attribute;
a number of puffs associated with the target vaping article;
a heating profile;
a flavor composition;
physical properties of the target vaping article; and
a composition of the target vaping article.

17. The method of claim 1, further comprising manufacturing the target vaping article based on the calculated values for the design parameter.

18. The method according to claim 1, wherein the target vaping article comprises the liquid formulation.

19. A non-combustible active substance delivery system, comprising the target vaping article of claim 1.

20. (canceled)

21. A non-transitory computer-readable storage medium comprising instructions which, when executed by a computer, cause the computer to carry out the method of claim 1.

22. A data processing apparatus comprising a processor and the computer-readable storage medium as claimed in claim 21.

23. A system comprising:
a data processing apparatus comprising a processor and a computer-readable storage medium; and
a vaping article manufacturing apparatus configured to carry out the method of claim 17.

24. A system comprising:
a vaping article manufactured according to the calculated values for the design parameters output by the method of claim 1.
